(19) United States
(12) Patent Application Publication
(10) Pub. No.: US 2018/0198827 A1
(43) Pub. Date: Jul. 12, 2018

(54) CONFIDENTIAL LEVELS IN REPUTABLE ENTITIES

(71) Applicant: Trend Micro Incorporated, Tokyo (JP)

(72) Inventors: Vaughn Kristopher EIFLER, Austin, TX (US); Jonathan Edward ANDERSSON, Austin, TX (US); Josiah Dede HAGEN, Austin, TX (US)

(73) Assignee: Trend Micro Incorporated, Tokyo (JP)

(21) Appl. No.: 15/913,035

(22) Filed: Mar. 6, 2018

Related U.S. Application Data
(63) Continuation of application No. PCT/US2015/050456, filed on Sep. 16, 2015.

(51) Int. Cl. H04L 29/06

(52) U.S. Cl. CPC H04L 63/20; H04L 63/101

(57) ABSTRACT

Examples disclosed herein relate to confidence levels in reputable entities. Some of the examples enable identifying a particular reputable entity that is originated from a plurality of sources including a first source and a second source; determining a first level of confidence associated with the first source; determining a second level of confidence associated with the second source; determining an aggregate level of confidence associated with the plurality of sources based on the first and second levels of confidence, wherein the aggregate level confidence is higher than the first and second levels of confidence; and determining an entity score for the particular reputable entity based on the aggregate level of confidence.

### CROSS-REFERENCE TO RELATED APPLICATION

This application is a continuation of International Application No. PCT/US2015/050456, with an International Filing Date of Sep. 16, 2015, which is incorporated herein by reference in its entirety.

### BACKGROUND

Examples of reputable entities may include Internet Protocol (IP) addresses, domain names, e-mail addresses, Uniform Resource Locators (URLs), files, software versions, security certificates, etc. A reputable entity may be originated from at least one of a plurality of sources, including various reputation services (e.g., threat intelligence feed providers). These services may supply the reputation information on reputable entities that provide information about threats the services have identified. The reputation information, for example, includes lists of domain names, IP addresses, and URLs that a reputation service has classified as malicious or at least suspicious according to different methods and criteria.

### BRIEF DESCRIPTION OF THE DRAWINGS

The following detailed description references the drawings, wherein:

FIG. 1 is a block diagram depicting an example environment in which various examples may be implemented as a confidence levels system.

FIG. 2 is a block diagram depicting an example confidence levels system.

FIG. 3 is a block diagram depicting an example machine-readable storage medium comprising instructions executable by a processor for determining confidence levels in reputable entities.

FIG. 4 is a block diagram depicting an example machine-readable storage medium comprising instructions executable by a processor for determining confidence levels in reputable entities.

FIG. 5 is a flow diagram depicting an example method for determining confidence levels in reputable entities.

FIG. 6 is a flow diagram depicting an example method for determining confidence levels in reputable entities.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Examples of reputable entities may include Internet Protocol (IP) addresses, domain names, e-mail addresses, Uniform Resource Locators (URLs), files, software versions, security certificates, etc. A reputable entity may be originated from at least one of a plurality of sources. For example, the reputable entity may be manually created and/or added to the system (e.g., confidence levels system 110) by a user (e.g., system administrator). In another example, a reputable entity may be originated from various reputation services (e.g., threat intelligence feed providers). These services and/or sources may supply the reputation information on reputable entities that provide information about threats the services have identified. The reputation information, for example, includes lists of domain names, IP addresses, and URLs that a reputation service has classified as malicious or at least suspicious according to different methods and criteria.

A reputable entity may be associated with and/or include a severity of a security threat posed by that reputable entity, a potential blocking impact of blocking the reputable entity from the network, and/or other parameters related to this reputable entity. Any combination of these parameters may be used to determine an entity score for the reputable entity. The entity score may be used, for example, to determine whether to include the particular reputable entity in a blacklist.

However, the severity, potential blocking impact, and/or other parameters of the reputable entity may need to be adjusted up or down depending how confident one can be in the values of those parameters. It may be technically challenging to determine a confidence level that measures the probability that these parameters accurately describe the reputable entity.

Examples disclosed herein provide technical solutions to these technical challenges by providing a technique to determine confidence levels in reputable entities. Various types of confidence levels may be determined for a particular reputable entity that is originated from a particular source, including but not being limited to: (1) a reputable entity confidence level (e.g., a level of confidence in the particular reputable entity and/or in a particular parameter (e.g., severity, potential blocking impact, etc.) of the particular reputable entity), (2) a source confidence level (e.g., a level of confidence in the information about the reputable entities that were previously originated from the particular source), and (3) a sample size confidence level (e.g., a level of confidence in a sample size of the network traffic data that is used to determine the potential blocking impact).

Some of the examples enable identifying a particular reputable entity that is originated from a plurality of sources including a first source and a second source; determining a first level of confidence associated with the first source based on: a first level of entity confidence in the particular reputable entity originated from the first source, a first level of source confidence in a first set of reputable entities previously originated from the first source, or a combination thereof; determining a second level of confidence associated with the second source based on: a second level of entity confidence in the particular reputable entity originated from the second source, a second level of source confidence in a second set of reputable entities previously originated from the second source, or a combination thereof; determining an aggregate level of confidence associated with the plurality of sources based on the first and second levels of confidence, wherein the aggregate level confidence is higher than the first and second levels of confidence; and determining an entity score for the particular reputable entity based on the aggregate level of confidence.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

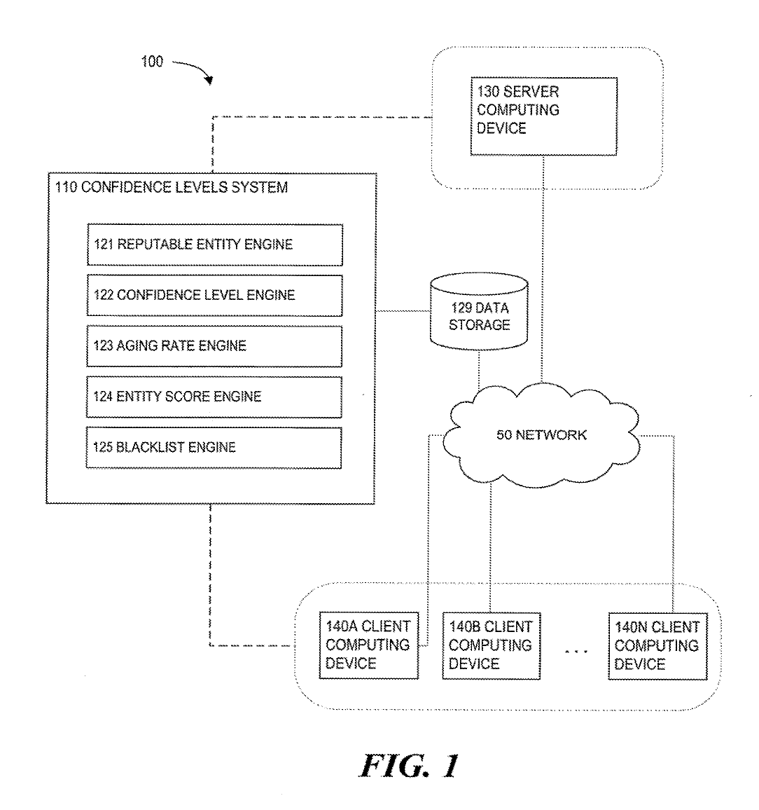

FIG. 1 is an example environment 100 in which various examples may be implemented as a confidence levels system 110. Confidence levels system 110 may include a server computing device in communication with client computing devices via a network 50. The client computing devices may communicate requests to and/or receive responses from the server computing device. The server computing device may receive and/or respond to requests from the client computing devices. The client computing devices may be any type of computing device providing a user interface through which a user can interact with a software application. For example, the client computing devices may include a laptop computing device, a desktop computing device, an all-in-one computing device, a thin client, a workstation, a tablet computing device, a mobile phone, an electronic book reader, a network-enabled appliance such as a “Smart” television, and/or other electronic device suitable for displaying a user interface and processing user interactions with the displayed interface. While the server computing device can be a single computing device, the server computing device may include any number of integrated or distributed computing devices.

Network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, confidence levels system 110 and the various components described herein may be implemented in hardware and/or a combination of hardware and programming that configures hardware. Furthermore, in FIG. 1 and other Figures described herein, different numbers of components or entities than depicted may be used.

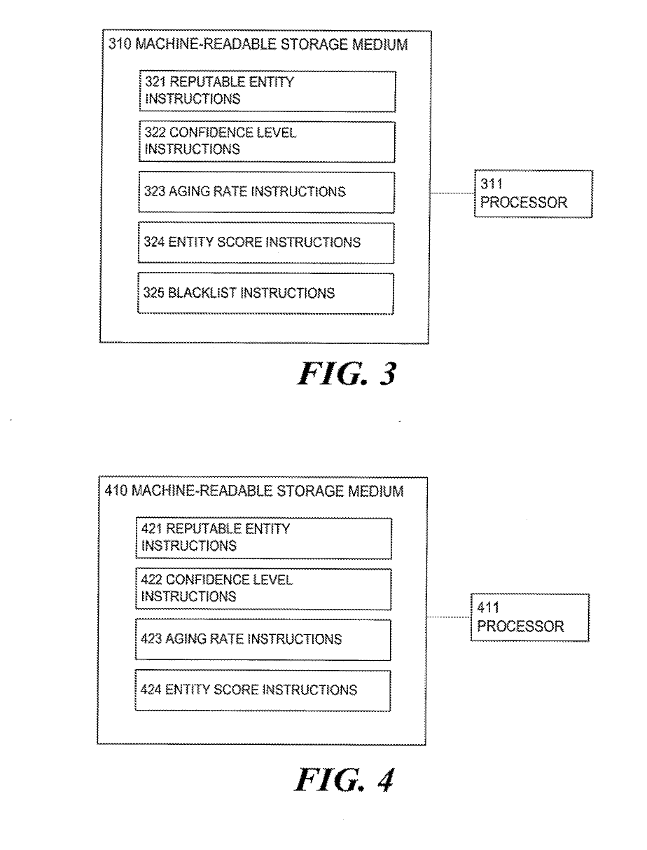

Confidence levels system 110 may comprise a reputable entity engine 121, a confidence level engine 122, an aging rate engine 123, an entity score engine 124, a blacklist engine 125, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Reputable entity engine 121 may obtain and/or identify reputable entities that are originated from at least one of a plurality of sources. At least some of these reputable entities may be used to generate and/or update a blacklist (e.g., as discussed in detail herein with respect to blacklist engine 125). A blacklist may comprise a plurality of reputable entities (e.g., Internet Protocol (IP) addresses, domain names, e-mail addresses, Uniform Resource Locators (URLs), files, software versions, security certificates, etc.). For example, the blacklist may be used to block, filter out, and/or deny access to certain resources by an event that matches at least one of the plurality of reputable entities. The reputable entities may be originated from a plurality of sources. In one example, a reputable entity may be manually created and/or submitted to confidence levels system 110 by a user (e.g., system administrator). In another example, a reputable entity may be originated from various reputation services (e.g., threat intelligence feed providers). These services and/or sources may supply the reputation information on reputable entities that provide information about threats the services have identified. The reputation information, for example, include lists of domain names, IP addresses, and URLs that a reputation service has classified as malicious or at least suspicious according to different methods and criteria.

In some implementations, a reputable entity may be associated with and/or include at least one parameter that describes the reputable entity. For example, the at least one parameter may include a severity of a security threat posed by the reputable entity, a potential blocking impact of blocking the reputable entity from the network, and/or other parameters related to this reputable entity. Any combination of these parameters may be used to determine an entity score for the reputable entity (e.g., as discussed in detail herein with respect to entity score engine 124). The entity score may be used, for example, to determine whether to include the particular reputable entity in the blacklist (e.g., as discussed in detail herein with respect to blacklist engine 125).

A severity parameter associated with a particular reputable entity may indicate the degree of severity of a security threat posed by that particular reputable entity. For example, if the particular reputable entity poses a security threat related to “Adware”, the severity with respect to that security threat may be low. If the particular reputable entity poses a security threat related to “Spam,” the severity may be higher than the one related to “Adware.” If the particular reputable entity poses a security threat related to an advanced persistent threat, the severity may be higher than the one related to “Spam.” The degree of severity may be represented in the form of a severity score (e.g., a numerical value), a severity level (e.g., low, medium, high, etc.), and/or other formats. The severity parameter of the particular reputable entity may be provided by the source from which the reputable entity is originated, may be determined by reputable entity engine 121, and/or may be obtained in any other ways.

A potential blocking impact parameter associated with the particular reputable entity may indicate the degree of impact of blocking that reputable entity from a network (e.g., the network at a customer site of a customer such as a recipient of the blacklist). For example, a customer (e.g., a recipient of the blacklist) may inadvertently block the reputable entity from their network without fully realizing the potential blocking impact of blocking the reputable entity. For example, blocking a popular search engine site (e.g., regardless of whether the site is a current security threat or not) may create a great deal of inconvenience to the users of the network.

In one example, the potential blocking impact may be determined based on user input (e.g., a customer such as a recipient of the blacklist may manually input and/or define a potential blocking impact of blocking a particular reputable entity of the blacklist). In another example, publicly available lists of popular reputable entities (e.g., popular websites, files, etc.) can be used to determine the potential blocking impact (e.g., the impact of blocking a popular website may be higher than the impact of blocking a website that is not popular or not frequently visited).

In another example, the potential blocking impact may be determined based on network traffic data of the network (e.g., the network at a customer site of a customer such as a recipient of a blacklist). For example, the network traffic data may comprise the record (e.g., a log file) of the data that is exchanged via the network, which may include but not be limited to domain name requests made by a user, Uniform Resource Locators (URLs) that the user visited, and files that the user has downloaded and/or uploaded. A user may refer to a network user that uses the network to access various resources. For example, a user may access a particular website (e.g., a resource) via the network (e.g., the network at a customer site of a customer such as a recipient of a blacklist). A user may refer to an individual person, an organization, and/or other entity. The user may be identified by a user login, an Internet Protocol (IP) address of a computing device that the user may use to access the network, and/or other types of user identifier. Each data item (e.g., a particular URL) in the network traffic data may be associated with the user (and/or the user identifier thereof) that initiated or otherwise used the data item. For example, a particular URL in the network traffic data may be associated with the user (and/or the user identifier thereof) who visited the particular URL via the network. As such, if a user (e.g., a first user) uses (e.g., accesses, downloads, uploads, visits, etc.) a particular reputable entity via the network, this occurrence of the particular reputable entity may be logged as part of the network traffic data. If the same user subsequently accesses the particular reputable entity via the same network, the network traffic data may include this subsequent occurrence of the particular reputable entity. If another user (e.g., a second user) accesses the same particular reputable entity via the network, the network traffic data may also include this occurrence of the particular reputable entity. In this case, the network traffic data may comprise 3 occurrences of the particular reputable entity. 2 of 3 occurrences are associated with the first user while the remaining one is associated with the second user.

The network traffic data may be analyzed to determine at least one parameter to be used to determine the potential blocking impact of the particular reputable entity. The at least one parameter may include not be limited to: a number of users that have used the reputable entity on the network (e.g., the network at the customer site) and a number of occurrences of the reputable entity (e.g., occurrences logged in the network traffic data). For example, if there are a large number of users accessing the same URL on the network, the potential blocking impact of blocking that URL may be great. Further, if there are a large number of occurrences of the URL detected in the network traffic data, the potential blocking impact of blocking this URL can be even greater. Note that the potential blocking impact has a direct correlationship with the number of users that have used the reputable entity on the network and/or the number of occurrences of the reputable entity. In other words, the potential blocking impact is higher if the number of users is higher. The impact is lower if the number of users is lower. The impact is higher if the number of occurrences is higher. The impact is lower if the number of occurrences is lower.

In some instances, the severity, potential blocking impact, and/or other parameters of the reputable entity may need to be adjusted up or down depending how confident one can be in the values of those parameters. As such, the severity, potential blocking impact, and/or other parameters of a reputable entity may be assigned with an associated confidence level. A technique to determine a confidence level that measures the probability that these parameters accurately describe the reputable entity is further discussed herein with respect to confidence level engine 122.

Confidence level engine 122 may determine various types of confidence levels regarding a particular reputable entity that is originated from a particular source, including but not being limited to: (1) a reputable entity confidence level (e.g., a level of confidence in the particular reputable entity and/or in a particular parameter (e.g., severity, potential blocking impact, etc.) of the particular reputable entity), (2) a source confidence level (e.g., a level of confidence in the information about the reputable entities that were previously originated from the particular source), and (3) a sample size confidence level (e.g., a level of confidence in a sample size of the network traffic data that is used to determine the potential blocking impact). Each of the above types of confidence levels is discussed in detail below.

(1) A reputable entity confidence level: This confidence level may refer to a level of confidence in the accuracy of the particular reputable entity and/or in the accuracy of a particular parameter (e.g., severity, potential blocking impact, etc.) of the particular reputable entity. Such a confidence level may be provided by that particular source itself (e.g., that provided the particular reputable entity to reputable entity engine 121), by another source, by confidence level engine 122, and/or by a user. For example, the source may believe that the reputable entity can pose a security threat of “medium” severity. In this case, the confidence level may represent the probability that the source's assessment of the severity (“medium”) is accurate. In this example, the source may have a 75% confidence level in the severity (“medium”) of the particular reputable entity that the source provided.

(2) A source confidence level: This confidence level may refer to a level of confidence in the particular source and/or in the accuracy of information provided by that source. This confidence level relates to the credibility associated with the source. For example, confidence level engine 122 may measure the accuracy of information about reputable entities that were previously originated from the particular source to determine the source confidence level. If the accuracy of the information previously provided by the particular source is high, the credibility associated with that source is high and thus the source confidence level would be also high. The accuracy of information about reputable entities that were previously originated from the particular source may be measured based on user/customer feedback (e.g., the reputable entities and/or parameters of the reputable entities may be published to users for them to determine the accuracy), correlating the particular source's information to information of other sources (e.g., if a larger number of the other sources agreed with the particular's source's information, the source confidence level associated with the particular source would be also higher), and/or any other ways.

(3) A sample size confidence level: This confidence level may refer to a level of confidence in a sample size of data that is used to determine a particular parameter of the reputable entity. For example, the confidence level may be determined based on a sample size (and/or a statistical significance thereof) of network traffic data that is used to determine a potential blocking impact of the reputable entity. In this example, the potential blocking impact may be determined based on a number of users that have used the reputable entity on the network and a sample size of users on the network. Confidence level engine 122 may determine a statistical significance of this sample size of users, and if it is high, the sample size confidence level may be high as well. In another example, the potential blocking impact may be determined based on a number of occurrences of the reputable entity and a sample size of network occurrences (e.g., a number of network packets). Confidence level engine 122 may determine a statistical significance of this sample size of network occurrences, and if it is high, the sample size confidence level may be high as well.

In some implementations, the confidence level types (1), (2), (3), or any combination thereof may be aggregated (e.g., combined into a single value) to generate and/or determine an aggregate confidence level. In one example, assuming that the entity confidence level is provided by a particular source and that the source confidence level refers to a level of confidence in that particular source, the confidence levels (1) and (2) may be combined to determine a level of confidence associated with the particular source. In some cases, the confidence levels (1) and (2) may be multiplied to determine this combined confidence level.

In another example, if the particular reputable entity is originated from a plurality of sources (e.g., N number of sources), confidence levels associated with each individual source of the plurality of sources may be aggregated to generate an aggregate confidence level. To understand this aggregation technique, consider the following example:

The plurality of sources may include a first source, a second source, and a third source. A first confidence level associated with the first source may be a first entity confidence level (e.g., that is provided by the first source), a first source confidence level (e.g., a level of confidence in the first source−the first source's credibility), and any combination thereof (e.g., as discussed above). A second confidence level associated with the second source may be a second entity confidence level (e.g., that is provided by the second source), a second source confidence level (e.g., a level of confidence in the second source−the second source's credibility), and any combination thereof. A third confidence level associated with the third source may be a third entity confidence level (e.g., that is provided by the third source), a third source confidence level (e.g., a level of confidence in the third source−the third source's credibility), and any combination thereof.

Assuming that the first confidence level associated with the first source equals to 0.9, the second confidence level associated with the second source equals to 0.8, and the third confidence level associated with the third source equals to 0.6, the aggregate confidence level of the first, second, and third confidence levels is 0.992. In this example, the aggregate confidence level of 0.992 is determined in the following manner: a=0+(the first confidence level of 0.9*(1−0))=0.9; b=a+(the second confidence level of 0.8*(1−a)=0.98; c=b+(the third confidence level of 0.6*(1−b)=0.992. As such, the aggregate confidence level is higher than the highest level of confidence among the first, second, and third levels of confidence (e.g., 0.992>0.9). Although the above example involved 3 sources, any number of sources may be used to determine an aggregate confidence level. The aggregate confidence level is higher than the highest level of confidence among all of those sources.

Aging rate engine 123 may determine an aging rate to be applied to a level of confidence (e.g., confidence level (1), (2), (3), or any combination thereof). For example, if a particular reputable entity and/or a parameter (e.g., severity, potential blocking impact, etc.) of the reputable entity has not been updated for a period of time, it makes sense to “age” or decrease (e.g., decrease by 1% per hour) the confidence level(s) that was previously determined for the particular reputable entity (and/or a particular parameter thereof).

In some implementations, the aging rate may be applied to a confidence level associated with a single source and/or an aggregate confidence level associated with multiple sources. In one example, aging rate engine 123 may determine a first aging rate associated with a first source based on a length of time passed since a last update on the particular reputable entity by the first source, a second aging rate associated with a second source based on a length of time passed since a last update on the particular reputable entity by the second source, a third aging rate associated with a third source based on a length of time passed since a last update on the particular reputable entity by the third source, and so on. In another example, aging rate engine 123 may determine an aging rate associated a plurality of sources based on a length of time passed since a last update on the particular reputable entity by any one of the plurality of sources. The aging rates may also vary based on a type of the particular reputable entity (e.g., IP address type, domain name type, security certificate type, etc.), a type of security threat (e.g., Adware, Spam, etc.) posed by the particular reputable entity, and/or other aging factors.

In some implementations, aging rate engine 123 may apply an aging rate to a confidence level in a way that the confidence level starts to age or decrease from the last update on the particular reputable entity. For example, if the aging rate equals to 3% per hour, the confidence level may decrease by 3% after 1 hour from the last update. In the next hour, another 3% would have been decreased. In other implementations, aging rate engine 123 may apply an aging rate to a confidence level in a way that the confidence level starts to age or decrease after a certain time period has passed since the last update. For example, individual sources may have different expected update interval. A first source may be expected to provide an update every 24 hours while a second source may be expected to provide an update every 48 hours. In this particular example, the confidence level for the first source may start to decrease after the first 24 hours have passed since the last update. For the second source, the confidence level may start to decrease after the first 48 hours have passed since the last update.

Entity score engine 124 may determine an entity score for the particular reputable entity based on at least one parameter (e.g., severity, potential blocking impact, etc.) of the reputable entity, a confidence level (e.g., confidence level (1), (2), (3), or any combination thereof), an aging rate, etc. For example, entity score engine 124 may determine the entity score by calculating: ((a first aging rate*a confidence level for severity)*severity)+((a second aging rate*a confidence level for potential blocking impact)*potential blocking impact). Note that each individual parameter of the reputable entity may be weighted by a corresponding confidence level (e.g., confidence level (1), (2), (3), or any combination thereof) and/or by the corresponding confidence level “aged” by a corresponding aging rate.

In some implementations, the entity score and/or the breakdown of the entity score (e.g., severity, potential blocking impact, confidence level, aging rate, etc.) may be used in various ways. In some implementations, the entity score may be used to determine a network policy to be applied to the reputable entity. Network policies may include not be limited to block, allow, quarantine, delay, notify, or any combination thereof (e.g., blocking the particular reputable entity from the network, allowing the particular reputable entity on the network, notifying at least one user of the particular reputable entity, isolating particular machines or users from the network, applying any particular network policy as defined by a user, etc.). In some implementations, confidence levels system 110 may use the entity score to determine (and/or select) a particular network policy and/or to directly apply the determined network policy to the reputable entity. In some implementations, the entity score may be provided to an external network device for the external network device to make the determination of the network policy and/or to apply the determined network policy to the reputable entity. In some implementations, a blacklist may be generated and/or updated based on the entity score, as further discussed herein with respect to blacklist engine 125.

In some implementations, the entity score and/or the breakdown of the entity score may be provided to various users and/or customers. The recipients of the entity score information may decide how to utilize the received information (e.g., utilize the information for research and analysis purposes, to determine a network policy, and/or to generate/update a blacklist or whitelist).

Blacklist engine 125 may generate and/or update a blacklist based on the entity score (e.g., as determined by entity score engine 124). In some implementations, the entity score of a particular reputable entity may be presented as part of the blacklist. For example, a representation (e.g., a numerical score) of the entity score may be shown adjacent to where the particular reputable entity is shown in the blacklist such that the customer (e.g., the recipient of the blacklist) can be readily informed of the severity, potential blocking impact, and/or other information regarding the reputable entity. With this additional information about the reputable entity present in the blacklist, the customer may make an informed decision on whether to keep the reputable entity in the blacklist or remove the entity from the blacklist. In some implementations, the entity score may be used as a parameter to determine and/or select reputable entities to be included in and/or excluded from the blacklist. Using the entity scores associated with a plurality of reputable entities, blacklist engine 125 may sort, rank, select, or otherwise determine the reputable entities that should be included in and/or excluded from the blacklist.

In performing their respective functions, engines 121-123 may access data storage 129 and/or other suitable database(s). Data storage 129 may represent any memory accessible to confidence levels system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Confidence levels system 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

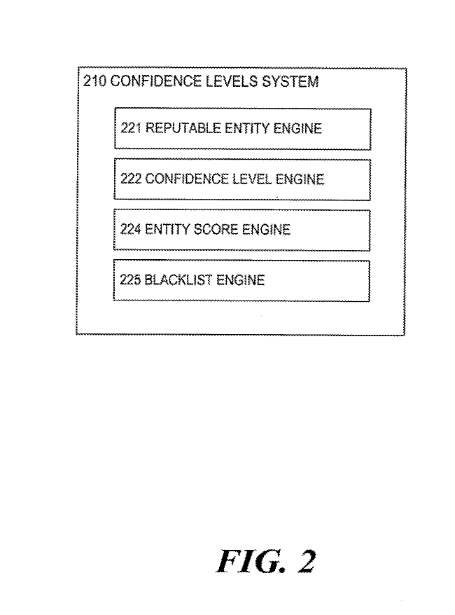

FIG. 2 is a block diagram depicting an example confidence levels system 210. Confidence levels system 210 may comprise a reputable entity engine 221, a confidence level engine 222, an entity score engine 224, a blacklist engine 225, and/or other engines. Engines 221, 222, 224, and 225 represent engines 121, 122, 124, and 125, respectively.

FIG. 3 is a block diagram depicting an example machine-readable storage medium 310 comprising instructions executable by a processor for determining confidence levels in reputable entities.

In the foregoing discussion, engines 121-125 were described as combinations of hardware and programming. Engines 121-125 may be implemented in a number of fashions. Referring to FIG. 3, the programming may be processor executable instructions 321-325 stored on a machine-readable storage medium 310 and the hardware may include a processor 311 for executing those instructions. Thus, machine-readable storage medium 310 can be said to store program instructions or code that when executed by processor 311 implements confidence levels system 110 of FIG. 1.

In FIG. 3, the executable program instructions in machine-readable storage medium 310 are depicted as reputable entity instructions 321, confidence level instructions 322, aging rate instructions 323, entity score instructions 324, and blacklist instructions 325. Instructions 321-325 represent program instructions that, when executed, cause processor 311 to implement engines 121-125, respectively.

FIG. 4 is a block diagram depicting an example machine-readable storage medium 410 comprising instructions executable by a processor for determining confidence levels in reputable entities.

Referring to FIG. 4, the programming may be processor executable instructions 421-424 stored on a machine-readable storage medium 410 and the hardware may include a processor 411 for executing those instructions. Thus, machine-readable storage medium 410 can be said to store program instructions or code that when executed by processor 411 implements confidence levels system 110 of FIG. 1.

In FIG. 4, the executable program instructions in machine-readable storage medium 410 are depicted as reputable entity instructions 421, confidence level instructions 422, aging rate instructions 423, and entity score instructions 424. Instructions 421-424 represent program instructions that, when executed, cause processor 411 to implement engines 121-124, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement confidence levels system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-325, and/or other instructions. As an alternative or in addition to retrieving and executing instructions, processor 311 may include at least one electronic circuit comprising a number of electronic components for performing the functionality of at least one of instructions 321-325, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-424, and/or other instructions. As an alternative or in addition to retrieving and executing instructions, processor 411 may include at least one electronic circuit comprising a number of electronic components for performing the functionality of at least one of instructions 421-424, and/or other instructions.

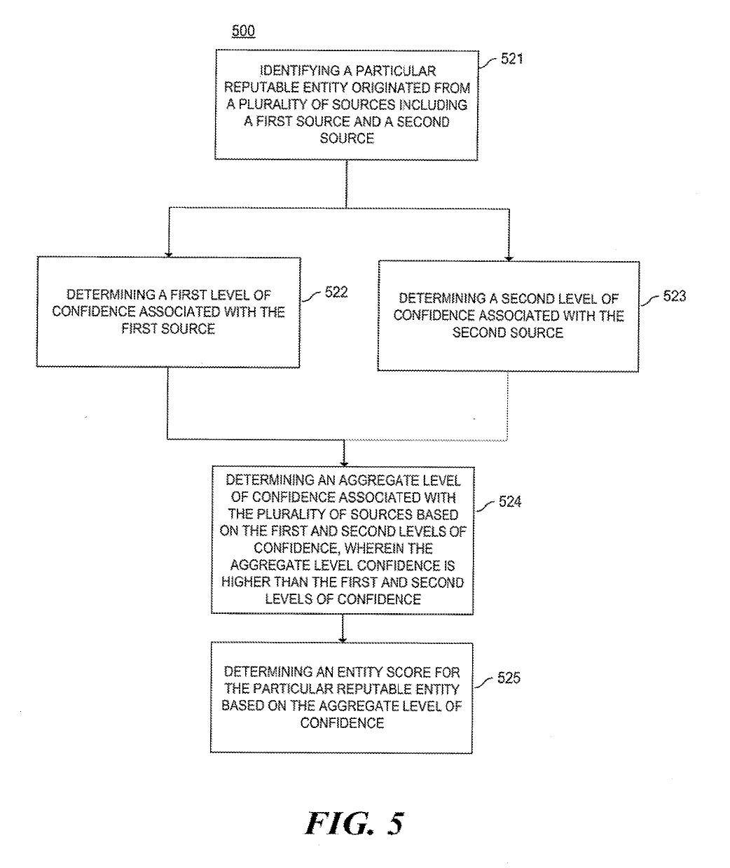

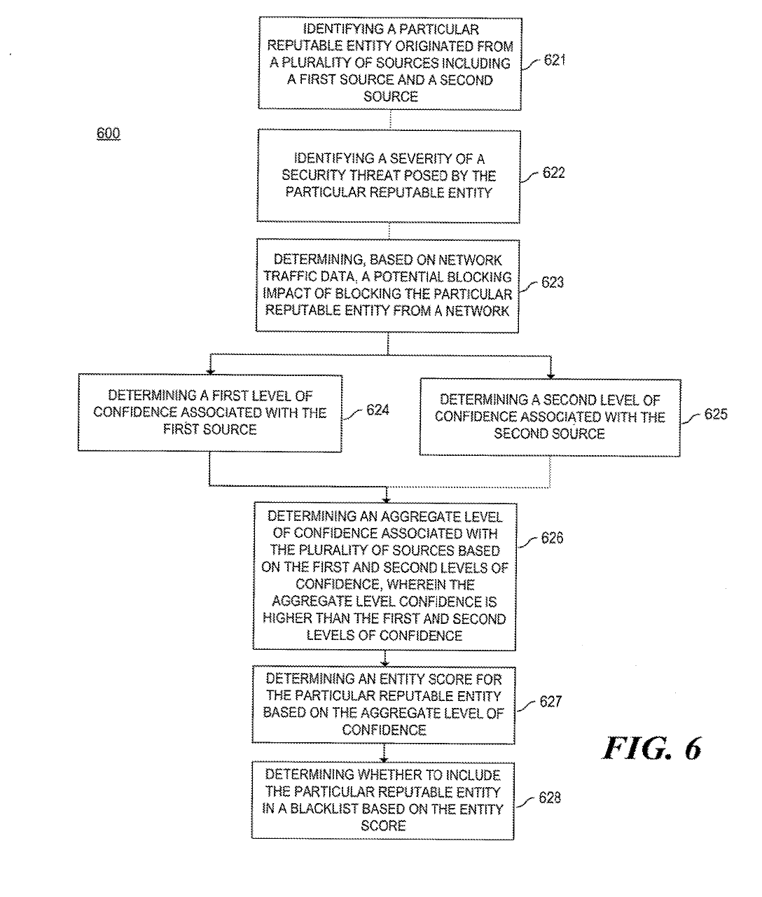

FIG. 5 is a flow diagram depicting an example method 500 for determining confidence levels in reputable entities. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant to be an example and, as such, should not be viewed as limiting. Method 500 may be implemented in the form of executable instructions stored on a machine-readable storage medium, such as storage medium 310, and/or in the form of electronic circuitry.

In block 521, method 500 may include identifying a particular reputable entity that is originated from a plurality of sources including a first source and a second source. Referring back to FIG. 1, reputable entity engine 121 may be responsible for implementing block 521.

In block 522, method 500 may include determining a first level of confidence associated with the first source based on: a first level of entity confidence in the particular reputable entity originated from the first source, a first level of source confidence in a first set of reputable entities previously originated from the first source, or a combination thereof. Referring back to FIG. 1, confidence level engine 122 may be responsible for implementing block 522.

In block 523, method 500 may include determining a second level of confidence associated with the second source based on: a second level of entity confidence in the particular reputable entity originated from the second source, a second level of source confidence in a second set of reputable entities previously originated from the second source, or a combination thereof. Referring back to FIG. 1, confidence level engine 122 may be responsible for implementing block 523.

In block 524, method 500 may include determining an aggregate level of confidence associated with the plurality of sources based on the first and second levels of confidence, wherein the aggregate level confidence is higher than the first and second levels of confidence. Referring back to FIG. 1, confidence level engine 122 may be responsible for implementing block 524.

In block 525, method 500 may include determining an entity score for the particular reputable entity based on the aggregate level of confidence. Referring back to FIG. 1, entity score engine 124 may be responsible for implementing block 525.

FIG. 6 is a flow diagram depicting an example method 600 for determining confidence levels in reputable entities. Method 600 as illustrated (and described in greater detail below) is meant to be an example and, as such, should not be viewed as limiting. Method 600 may be implemented in the form of executable instructions stored on a machine-readable storage medium, such as storage medium 310, and/or in the form of electronic circuitry.

In block 621, method 600 may include identifying a particular reputable entity that is originated from a plurality of sources including a first source and a second source. Referring back to FIG. 1, reputable entity engine 121 may be responsible for implementing block 621.

In block 622, method 600 may include identifying a severity of a security threat posed by the particular reputable entity. Referring back to FIG. 1, reputable entity engine 121 may be responsible for implementing block 622.

In block 623, method 600 may include determining, based on network traffic data, a potential blocking impact of blocking the particular reputable entity from a network. Referring back to FIG. 1, reputable entity engine 121 may be responsible for implementing block 623.

In block 624, method 600 may include determining a first level of confidence associated with the first source based on: a first level of entity confidence in the particular reputable entity originated from the first source, a first level of source confidence in a first set of reputable entities previously originated from the first source, or a combination thereof. Referring back to FIG. 1, confidence level engine 122 may be responsible for implementing block 624.

In block 625, method 600 may include determining a second level of confidence associated with the second source based on: a second level of entity confidence in the particular reputable entity originated from the second source, a second level of source confidence in a second set of reputable entities previously originated from the second source, or a combination thereof. Referring back to FIG. 1, confidence level engine 122 may be responsible for implementing block 625.

In block 626, method 600 may include determining an aggregate level of confidence associated with the plurality of sources based on the first and second levels of confidence, wherein the aggregate level confidence is higher than the first and second levels of confidence. Referring back to FIG. 1, confidence level engine 122 may be responsible for implementing block 626.

In block 627, method 600 may include determining an entity score for the particular reputable entity based on the aggregate level of confidence. Referring back to FIG. 1, entity score engine 124 may be responsible for implementing block 627.

In block 628, method 600 may include determining whether to include the particular reputable entity in a blacklist based on the entity score. Referring back to FIG. 1, blacklist engine 125 may be responsible for implementing block 628.

The foregoing disclosure describes a number of example implementations for confidence levels in reputable entities. The disclosed examples may include systems, devices, computer-readable storage media, and methods for confidence levels in reputable entities. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for determining confidence levels in reputable entities, the method comprising:
identifying a particular reputable entity that is originated from a plurality of sources including a first source and a second source;
determining a first level of confidence associated with the first source based on: a first level of entity confidence in the particular reputable entity originated from the first source, a first level of source confidence in a first set of reputable entities previously originated from the first source, or a combination thereof;
determining a second level of confidence associated with the second source based on: a second level of entity confidence in the particular reputable entity originated from the second source, a second level of source confidence in a second set of reputable entities previously originated from the second source, or a combination thereof;
determining an aggregate level of confidence associated with the plurality of sources based on the first and second levels of confidence, wherein the aggregate level confidence is higher than the first and second levels of confidence; and
determining an entity score for the particular reputable entity based on the aggregate level of confidence.

2. The method of claim 1, further comprising:
determining whether to include the particular reputable entity in a blacklist based on the entity score.

3. The method of claim 1, further comprising:
identifying a severity of a security threat posed by the particular reputable entity; and
determining the entity score for the particular reputable entity based on the severity that is weighted by the aggregate level of confidence.

4. The method of claim 1, further comprising:
obtaining network traffic data of a network that is accessible by a plurality of users, the network traffic data comprising occurrences of the particular reputable entity;
determining, based on the network traffic data, a potential blocking impact of blocking the particular reputable entity from the network; and
determining the entity score for the particular reputable entity based on the potential blocking impact that is weighted by the aggregate level of confidence.

5. The method of claim 4, further comprising:
providing the potential blocking impact to be used in an application of a network policy to the particular reputable entity, the network policy comprising blocking the particular reputable entity from the network, allowing the particular reputable entity on the network, notifying at least one user of the particular reputable entity, isolating particular machines or users from the network, applying any particular network policy as defined by a user, or a combination thereof.

6. The method of claim 4, further comprising:
determining a third level of confidence associated with a sample size of the network traffic data; and
determining the entity score for the particular reputable entity based on the potential blocking impact that is weighted by the third level of confidence.

7. The method of claim 6, wherein determining the third level of confidence comprises:
determining a statistical significance of the sample size; and
determining the third level of confidence based on the statistical significance.

8. A non-transitory machine-readable storage medium comprising instructions executable by a processor of a computing device for determining confidence levels in reputable entities, the machine-readable storage medium comprising:
instructions to identify a particular reputable entity that is originated from a plurality of sources including a first source and a second source;
instructions to determine a first level of confidence associated with the first source based on: a first level of entity confidence in the particular reputable entity originated from the first source, a first level of source confidence in a first set of reputable entities previously originated from the first source, or a combination thereof;
instructions to apply a first aging rate to the first level of confidence if the first source fails to provide an update on the particular reputable entity for a first time period;
instructions to determine a second level of confidence associated with the second source based on: a second level of entity confidence in the particular reputable entity originated from the second source, a second level of source confidence in a second set of reputable entities previously originated from the second source, or a combination thereof;
instructions to apply a second aging rate to the second level of confidence if the second source fails to provide the update on the particular reputable entity for a second time period;
instructions to determine an aggregate level of confidence associated with the plurality of sources by aggregating the first and second levels of confidence; and
instructions to determine an entity score for the particular entity based on the aggregate level of confidence.

9. The non-transitory machine-readable storage medium of claim 8, further comprising:
instructions to determine an entity score for the particular reputable entity based on a severity that is weighted by the aggregate level of confidence, a potential blocking impact that is weighted by the aggregate level of confidence, or a combination thereof; and
instructions to determine whether to include the particular reputable entity in a blacklist based on the entity score.

10. The non-transitory machine-readable storage medium of claim 8, wherein the plurality of sources include a third source, further comprising:
instructions to determine a third level of confidence associated with the third source based on a third level of entity confidence in the particular reputable entity originated from the third source, a third level of source confidence in a third set of reputable entities previously originated from the third source, or a combination thereof; and
instructions to update the aggregate level of confidence, wherein the aggregate level of confidence is higher than the highest level of confidence among the first, second, and third levels of confidence.

11. The non-transitory machine-readable storage medium of claim 8, further comprising:
instructions to determine the first aging rate associated with the first source based on a length of time passed since a last update on the particular reputable entity by the first source, a type of the particular reputable entity, a type of security threat posed by the particular reputable entity, or a combination thereof.

12. A system for determining confidence levels in reputable entities comprising:
a processor that:
identifies a particular reputable entity that is originated from a source;
obtains network traffic data of a network that is accessible by a plurality of users, the network traffic data comprising occurrences of the particular reputable entity;
determines, based on the network traffic data, a potential blocking impact of blocking the particular reputable entity from the network; and
determines a first level of confidence associated with a sample size of the network traffic data;
determines an entity score for the particular reputable entity based on the potential blocking impact that is weighted by the first level of confidence; and
provides the entity score to determine a network policy to be applied to the particular reputable entity.

13. The system of claim 12, the processor that:
determines, based on the network traffic data, at least one of: a number of users that have used the particular reputable entity on the network and a number of the occurrences of the particular reputable entity; and
determines the potential blocking impact based on: the number of users that have used the particular reputable entity, the number of the occurrences of the particular reputable entity, or a combination thereof.

14. The system of claim 12, the processor that:
determines a second level of confidence associated with the source based on: a level of entity confidence in the particular reputable entity originated from the source, a level of source confidence in a set of reputable entities previously originated from the source, or a combination thereof; and
determines the entity score for the particular reputable entity based on the potential blocking impact that is weighted by: the first level of confidence and the second level of confidence, or a combination thereof;

15. The system of claim 12, the processor that:
determines a second level of confidence associated with the source based on: a level of entity confidence in the particular reputable entity originated from the source, a level of source confidence in a set of reputable entities previously originated from the source, or a combination thereof; and
identifies a severity of a security threat posed by the particular reputable entity; and
determines the entity score for the particular reputable entity based on the severity that is weighted by the second level of confidence.
